(19) United States
(12) Patent Application Publication
(10) Pub. No.: US 2018/0074946 A1
(43) Pub. Date: Mar. 15, 2018

(54) USING CUSTOMER PROFILING AND ANALYTICS TO CREATE A RELATIVE, TARGETED, AND IMPACTFUL CUSTOMER PROFILING ENVIRONMENT/WORKLOAD QUESTIONNAIRE

(71) Applicant: International Business Machines Corporation, Armonk, NY (US)

(72) Inventors: Thomas W. Conti, Poughkeepsie, NY (US); Kyle R. Moser, Stone Ridge, NY (US)

(21) Appl. No.: 15/264,629

(22) Filed: Sep. 14, 2016

(51) Int. Cl. G06F 11/36

(52) U.S. Cl. CPC G06F 11/3688; G06F 11/3604

(57) ABSTRACT

Aspects of the present invention include a method, system and computer program product. The method includes a processor collecting data relating to a specific customer, the data relating to testing of at least one discipline of a specific customer; collecting data relating to the specific customer, the data being segmented by one or more functional areas or focal areas; collecting data relating to the specific customer, the data being segmented by an industry to which the specific customer belongs; collecting data relating to the specific customer, the data being segmented by geography, country and/or culture to which the specific customer belongs; determining that one or more additional issues exist relating to the data relating to the specific customer, and collecting data relating to the one or more additional issues; and creating a customer profiling environment and workload data questionnaire profiled to the specific customer.

### BACKGROUND

The present invention relates to the testing of software, hardware, firmware, and/or other disciplines, and more specifically, to a method, system and computer program product that implement aspects of workload and operational profiling, coupled with business analytics, thereby resulting in improvements in the testing of customer software.

In the field of software testing, as in many other technical fields, improvements are constantly being sought, primarily for cost and accuracy reasons. A fundamental goal of software testing in theory is to identify all of the problems in a customer's software program before the program is released for use by the customer. However, in reality this is far from the case as typically a software program is released to the customer having some number of problems that were unidentified during the software development and testing process.

A relatively more proactive approach to improving software testing is sought that employs traditional methods of understanding characteristics of clients' environments, augmented with a process of data mining empirical systems data. Such client environment and workload profiling analysis may result in software test improvements based on characteristics comparisons between the client and the test environments.

### SUMMARY

According to one or more embodiments of the present invention, a computer-implemented method includes collecting, by a processor, data relating to a specific customer, the data relating to testing of at least one discipline of a specific customer; collecting, by the processor, data relating to the specific customer, the data being segmented by one or more functional areas or focal areas; and collecting, by the processor, data relating to the specific customer, the data being segmented by an industry to which the specific customer belongs. The method also includes collecting, by the processor, data relating to the specific customer, the data being segmented by geography, country and/or culture to which the specific customer belongs; determining, by the processor, that one or more additional issues exist relating to the data relating to the specific customer, and collecting, by the processor, data relating to the one or more additional issues; and creating, by the processor, a customer profiling environment and workload data questionnaire profiled to the specific customer.

According to another embodiment of the present invention, a system includes a processor in communication with one or more types of memory, the processor configured to collect data relating to a specific customer, the data relating to testing of at least one discipline of a specific customer; to collect data relating to the specific customer, the data being segmented by one or more functional areas or focal areas; and to collect data relating to the specific customer, the data being segmented by an industry to which the specific customer belongs. The processor is further configured to collect data relating to the specific customer, the data being segmented by geography, country and/or culture to which the specific customer belongs; to determine that one or more additional issues exist relating to the data relating to the specific customer, and to collect data relating to the one or more additional issues; and to create a customer profiling environment and workload data questionnaire profiled to the specific customer.

According to yet another embodiment of the present invention, a computer program product includes a non-transitory storage medium readable by a processing circuit and storing instructions for execution by the processing circuit for performing a method that includes collecting data relating to a specific customer, the data relating to testing of at least one discipline of a specific customer; collecting data relating to the specific customer, the data being segmented by one or more functional areas or focal areas; and collecting data relating to the specific customer, the data being segmented by an industry to which the specific customer belongs. The method also includes collecting data relating to the specific customer, the data being segmented by geography, country and/or culture to which the specific customer belongs; determining that one or more additional issues exist relating to the data relating to the specific customer, and collecting data relating to the one or more additional issues; and creating a customer profiling environment and workload data questionnaire profiled to the specific customer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein; and

FIG. 4 is a flow diagram of a method for utilizing current and historical customer information to develop or create a targeted environment and workload data and/or information questionnaire profiled to a specific customer in accordance with one or more embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

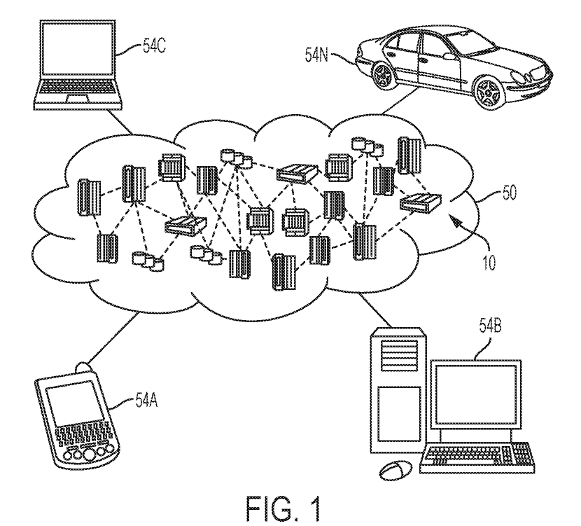

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

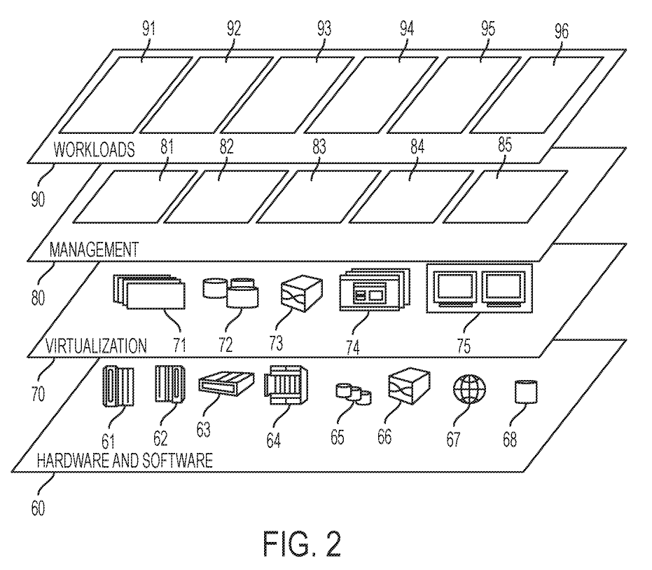

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for utilizing current and historical customer information to develop or create a targeted environment and workload questionnaire profiled to a specific customer in accordance with one or more embodiments of the present invention.

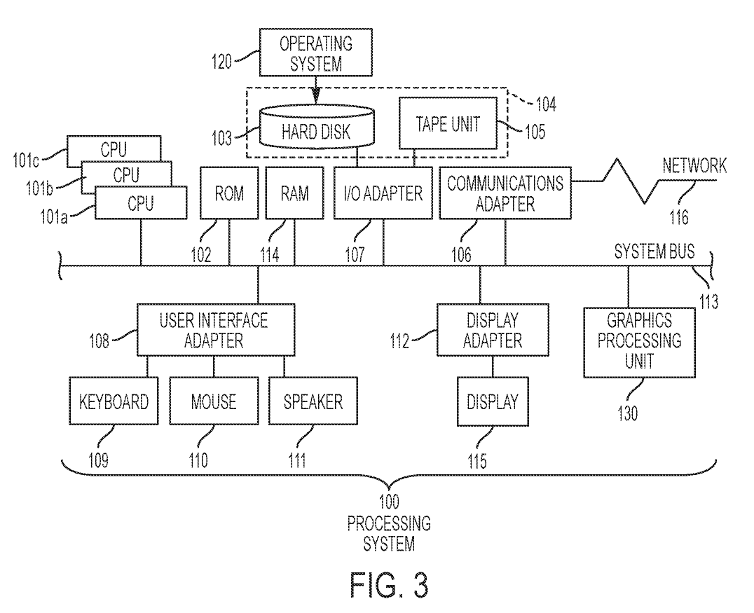

Referring to FIG. 3, there is shown a processing system 100 for implementing the teachings herein according to one or more embodiments. The system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with one or more embodiments of the present invention, methods, systems, and computer program products are disclosed for utilizing current and historical customer information to develop or create a targeted environment and workload questionnaire profiled to a specific customer.

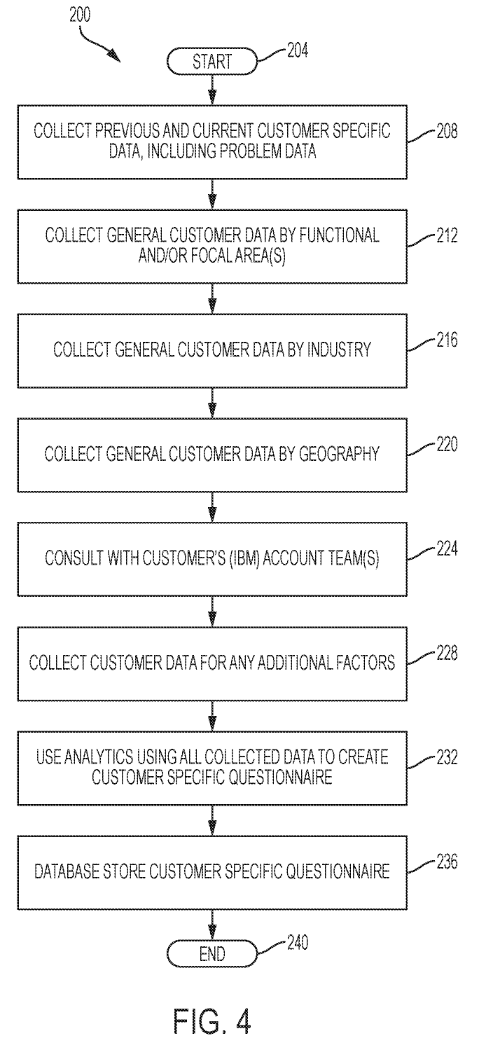

With reference now to FIG. 4, a flow diagram illustrates a method 200 according to one or more embodiments of the present invention for utilizing current and historical customer information to develop or create a targeted environment and workload questionnaire profiled to a specific customer.

In one or more embodiments of the present invention, the method 200 may be embodied in software that is executed by computer elements located within a network that may reside in the cloud, such as the cloud computing environment 50 described hereinabove and illustrated in FIGS. 1 and 2. In other embodiments, the computer elements may reside on a computer system or processing system, such as the processing system 100 described hereinabove and illustrated in FIG. 3, or in some other type of computing or processing environment.

After a start operation in block 204, an operation in block 208 collects previous (i.e., historical) and/or current test-related data or information/knowledge that is specific to a particular customer, the data or information including problem history, any available environment and workload information, and any relevant empirical data. The data or information/knowledge may be related to one or more disciplines of a customer, including, for example, software, hardware and/or firmware.

An operation in block 212 utilizes existing customer profiling databases to collect general customer information and data, including operational, environmental, workload, application, the data or information being segmented by functional area(s) and/or focal area(s). This includes information and data related to the customer, the business entity, and business partners regarding focal areas or initiatives, such as software and/or hardware installs, migrations, upgrades, new function adoption, data center migrations, etc. The data or information/knowledge may be related to one or more disciplines of a customer, including, for example, software, hardware and/or firmware.

An operation in block 216 utilizes existing customer profiling databases to collect general customer information and data (e.g., operational, environmental, workload, application), the data or information being segmented by the customer industry to which the targeted customer belongs. The data or information/knowledge may be related to one or more disciplines of a customer, including, for example, software, hardware and/or firmware.

An operation in block 220 utilizes existing customer profiling databases to collect general customer information and data, including operational, environmental, workload, application, the data or information being segmented by geography, country, and/or culture to which the targeted customer belongs, as well as the overall global customer set. The data or information/knowledge may be related to one or more disciplines of a customer, including, for example, software, hardware and/or firmware.

An operation in block 224 determines if there are any additional customer specific issues, functional areas, and/or other concerns relating to the data of the specific customer for which to focus the profiling questionnaire. Part of this includes reviewing data known to the business entity regarding the specific or targeted customer (e.g., consult with the account team(s) for the targeted customer regarding, for example, any additional focal areas of that customer).

An operation in block 228 collects any additional customer data that may be required after reviewing data known to the business entity regarding the specific or targeted customer (e.g., after consulting with the account team(s) for the targeted customer and determining if there are any customer specific issues, functional areas, and/or other concerns for which to focus the profiling questionnaire).

An operation in block 232 develops or creates a customer specific relative, targeted, and impactful customer profiling environment and workload data and/or information questionnaire profiled to a specific customer. This may be accomplished using the customer specific and general customer information collected in one or more of the operations in the blocks 208, 212, 216, 220 discussed hereinabove, together with various customer profiling and analytics techniques.

The targeted, specific, and relative profiling environment and workload questionnaire for the specific customer may include information or data regarding various characteristics of the customer's current situation. Current customer situation characteristics or components that may be incorporated into the individual customer profiling questionnaire include: geography, country, and/or culture trends, including specific and unique characteristics thereof; industry trends, including specific and unique characteristics thereof; customer problem history considerations (historical, current, or both); customer focal areas or initiatives, such as software and/or hardware installs, migrations, upgrades, new function adoption, data center migrations, etc.; business entity focal areas or initiatives, including those covered above for the specific customer; and business partner focal areas or initiatives, including those covered above for the specific customer.

An operation in block 236 stores the customer specific data and/or information questionnaire, for example, in the customer profiling database, for current and future reference, comparison, analytics, and other operations. The method 200 then ends in an operation in block 240.

In embodiments of the present invention, the targeted environment and workload questionnaire profiled to a specific customer is developed or created to collect as much pertinent, relatively high value information as possible about the targeted customer. This is so that in-depth, valuable analyses and comparisons of the customer in relation to the business entity (e.g., IBM) and various customer sets may be initiated through targeted data collection and then performed, and with relatively little need for follow-up requests from the customer for additional data for this profiling effort.

Embodiments of the present invention generate a targeted, specific, and relative environment and workload questionnaire for a specific customer, including by geography, country, culture, industry, cross platforms, and/or other current focal areas of interest for the customer, the business entity (e.g., IBM), or both. The detailed environment and workload questionnaire may include the following base sections, with a number of sub-sections and questions contained within each section, tailored as needed to the specific customer environment and workload or situation: hardware environment; software environment; application environment; and change control. When completed by the customer and returned to the business entity, the questionnaire help the business entity to better understand the customer's software, hardware, and/or firmware environments, workloads, procedures, resources, problems, best practices adoption, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
collecting, by a processor, data relating to a specific customer, the data relating to testing of at least one discipline of a specific customer;
collecting, by the processor, data relating to the specific customer, the data being segmented by one or more functional areas or focal areas;
collecting, by the processor, data relating to the specific customer, the data being segmented by an industry to which the specific customer belongs;
collecting, by the processor, data relating to the specific customer, the data being segmented by geography, country and/or culture to which the specific customer belongs;
determining, by the processor, that one or more additional issues exist relating to the data relating to the specific customer, and collecting, by the processor, data relating to the one or more additional issues; and
creating, by the processor, a customer profiling environment and workload data questionnaire profiled to the specific customer.

2. The computer-implemented method of claim 1 wherein the at least one discipline of a specific customer comprises software, hardware or firmware.

3. The computer-implemented method of claim 1 wherein data relating to a specific customer comprises current data and/or historical data.

4. The computer-implemented method of claim 1 wherein data relating to a specific customer comprises data relating to problem history, environment and workload data, and empirical data.

5. The computer-implemented method of claim 1 wherein one or more functional areas or focal areas comprise software and/or hardware installs, migrations, upgrades, new function adoption, data center migrations.

6. The computer-implemented method of claim 1 wherein data relating to a specific customer comprises data relating to operational, environmental, workload or application of a specific customer.

7. The computer-implemented method of claim 1 further comprising storing, by the processor, in a database the customer profiling environment and workload data questionnaire profiled to the specific customer.

8. A system comprising:
a processor in communication with one or more types of memory, the processor configured to:
collect data relating to a specific customer, the data relating to testing of at least one discipline of a specific customer;
collect data relating to the specific customer, the data being segmented by one or more functional areas or focal areas;
collect data relating to the specific customer, the data being segmented by an industry to which the specific customer belongs;
collect data relating to the specific customer, the data being segmented by geography, country and/or culture to which the specific customer belongs;
determine that one or more additional issues exist relating to the data relating to the specific customer, and collect data relating to the one or more additional issues; and
create a customer profiling environment and workload data questionnaire profiled to the specific customer.

9. The system of claim 8 wherein the at least one discipline of a specific customer comprises software, hardware or firmware.

10. The system of claim 8 wherein data relating to a specific customer comprises current data and/or historical data.

11. The system of claim 8 wherein data relating to a specific customer comprises data relating to problem history, environment and workload data, and empirical data.

12. The system of claim 8 wherein one or more functional areas or focal areas comprise software and/or hardware installs, migrations, upgrades, new function adoption, data center migrations.

13. The system of claim 8 wherein data relating to a specific customer comprises data relating to operational, environmental, workload or application of a specific customer.

14. The system of claim 8 the processor further configured to store in a database the customer profiling environment and workload data questionnaire profiled to the specific customer.

15. A computer program product comprising:
a non-transitory storage medium readable by a processing circuit and storing instructions for execution by the processing circuit for performing a method comprising:
collecting data relating to a specific customer, the data relating to testing of at least one discipline of a specific customer;
collecting data relating to the specific customer, the data being segmented by one or more functional areas or focal areas;
collecting data relating to the specific customer, the data being segmented by an industry to which the specific customer belongs;
collecting data relating to the specific customer, the data being segmented by geography, country and/or culture to which the specific customer belongs;
determining that one or more additional issues exist relating to the data relating to the specific customer, and collecting data relating to the one or more additional issues; and
creating a customer profiling environment and workload data questionnaire profiled to the specific customer.

16. The computer program product of claim 15 wherein the at least one discipline of a specific customer comprises software, hardware or firmware.

17. The computer program product of claim 15 wherein data relating to a specific customer comprises current data and/or historical data.

18. The computer program product of claim 15 wherein data relating to a specific customer comprises data relating to problem history, environment and workload data, and empirical data.

19. The computer program product of claim 15 wherein one or more functional areas or focal areas comprise software and/or hardware installs, migrations, upgrades, new function adoption, data center migrations.

20. The computer program product of claim 15 further comprising storing in a database the customer profiling environment and workload data questionnaire profiled to the specific customer.
